(19) United States
(12) Patent Application Publication
(10) Pub. No.: US 2011/0259379 A1
(43) Pub. Date: Oct. 27, 2011

(54) WASH WAND ATTACHMENT SYSTEM

(76) Inventor: Thomas P. Smith, Winfield, IL (US)

(21) Appl. No.: 13/090,470

(22) Filed: Apr. 20, 2011

Related U.S. Application Data
(60) Provisional application No. 61/326,951, filed on Apr. 22, 2010.

(51) Int. Cl. B08B 3/00

(52) U.S. Cl. 134/198

(57) ABSTRACT

A wash wand attachment system is provided, including a wash wand having a first end configured for receiving an attachment and defining a longitudinal axis, a key formation secured to the first end and having a releasable latch, and a wand attachment having a socket configured for releasably receiving the key formation. The key formation and the socket are constructed and arranged such that upon relative engagement, the attachment is prevented from rotational movement about the axis, and also from movement in the direction of the axis.

### RELATED APPLICATION

This application is a Non-Provisional of, and claims 35 USC 119(e) priority from U.S. Provisional Application Ser. No. 61/326,951 filed Apr. 22, 2010.

### BACKGROUND

The present invention relates to wash wands used for washing or cleaning vehicles, windows, siding and other hard to reach items, and more specifically to wash wands with releasable wash attachments.

Conventional wash wands include elongate handles with attachment ends that are typically threaded in the manner of a broomstick to be threadably received in a socket of an attachment such as a brush. Consumers use these brushers for washing autos, as well as larger vehicles including SUV's and trucks, where the long wands extend the user's reach and increase the ability to clean areas otherwise difficult to access.

A main drawback of such systems is that during use, the threaded engagement loosens and the attachment begins to rotate axially relative to the handle. The user then is forced to interrupt the washing operation and retighten the attachment to the handle. In some cases, this process must be repeated several times in the course of the washing project. Aside from the extra time involved, if the attachment disconnects from the wand, it may scratch the vehicle. Also, this repeated interruption aggravates some users to the extent that they no longer desire to use the wash wand. Manufacturers of such products prefer to prevent the development of negative attitudes among consumers. Also, conventional, thread-on attachments are fairly tedious to exchange or replace. Another drawback of conventional wash wands is that the handles of different manufacturers have different gauges or diameters, and as such are not interchangeable with a variety of attachments.

Some conventional wash wands have hollow handles and are configured for connection to a source of pressurized water, such as a garden hose. Upon assembly of the attachment, water is emitted through the attachment. However, when the attachment becomes loose relative to the handle, due to the unthreading described above, water can flow down the handle to the user's hands, causing discomfort, and/or making the wand more difficult to hold and control.

### SUMMARY

The above-identified drawbacks of conventional wash wand systems are met by the present wash wand attachment system, in which the wash wand has a handle portion with a key formation including a releasable latch. The key formation is configured so that upon mating engagement with a complementary socket in an attachment, the attachment is securely held to the wand and is prevented from rotation and axial movement relative to the wand.

In addition, the attachment is easily releasable from the wand by depression of a spring-loaded latch button. Thus, multiple attachments are connectable to a single wand. Exchange of attachments is relatively easily accomplished in a single motion using one hand and without the use of tools. The user merely presses the latch button while grasping and pulling the attachment axially away from the wand. When the wand is provided with an internal passageway for water transport, for use in applications when the wand is connected to a pressurized water source, such as a garden hose, the key formation includes a water conduit that is kept separate from the latch.

More specifically, a wash wand attachment system is provided, including a wash wand defining a longitudinal axis and having a first end configured for receiving an attachment, a key formation secured to the first end and having a releasable latch, and a wand attachment having a socket configured for releasably receiving the key formation. The key formation and the socket are constructed and arranged such that upon engagement, the attachment is prevented from rotational movement about the axis, and also from movement in the direction of the axis.

In another embodiment, a wash attachment is provided for use with a wash wand attachment system including a wash wand defining a longitudinal axis and having a first end configured for receiving the attachment, a key formation secured to the first end and having a releasable latch. The attachment includes a wand attachment body having a working portion and a generally “+”-shaped socket including a rectangular latch portion and a generally cylindrical water conduit portion in communication with an adjacent planar surface of the latch portion and configured for releasably receiving the key formation. The socket is constructed and arranged such that upon relative engagement with the key formation, the attachment is prevented from rotational movement about the axis, and also from movement in the direction of the axis.

In yet another embodiment, a wash wand is provided for use with a wash wand attachment system, including a wand attachment having a socket for releasably engaging the wash wand, the socket having a wand attachment body having a working portion and a generally “+”-shaped socket including a rectangular latch portion and a generally cylindrical water conduit portion in communication with an adjacent planar surface of the latch portion and configured for releasably receiving the wash wand. The wand includes a wash wand having a handle portion defining a longitudinal axis and provided with a first end configured for receiving the attachment, a key formation secured to the first end and having a releasable latch, the key formation is generally “+”-shaped when viewed on end, including a rectangular latch with a generally cylindrical water conduit secured to a lower edge of the latch and a retractable latch button projecting from the rectangular latch opposite the water conduit. The key formation is constructed and arranged such that upon relative engagement with the attachment socket, the attachment is prevented from rotational movement about the axis, and also from movement in the direction of the axis.

### BRIEF DESCRIPTION OF THE DRAWINGS

FIG. 1 is a plan elevation of a wash wand equipped with the present attachment system;

FIG. 2 is an inverted cross-section taken along the line 2-2 of FIG. 1 and in the direction generally indicated;

FIG. 3 is a fragmentary enlarged cross-section of the structure depicted in FIG. 2;

FIG. 4 is a side elevation of the present wand latch member in partial section;

FIG. 5 is a front elevation of the wand latch member of FIG. 4; and

FIG. 6 is a plan elevation of a wand attachment suitable for use with the present system and equipped with an embodiment of the present socket.

### DETAILED DESCRIPTION

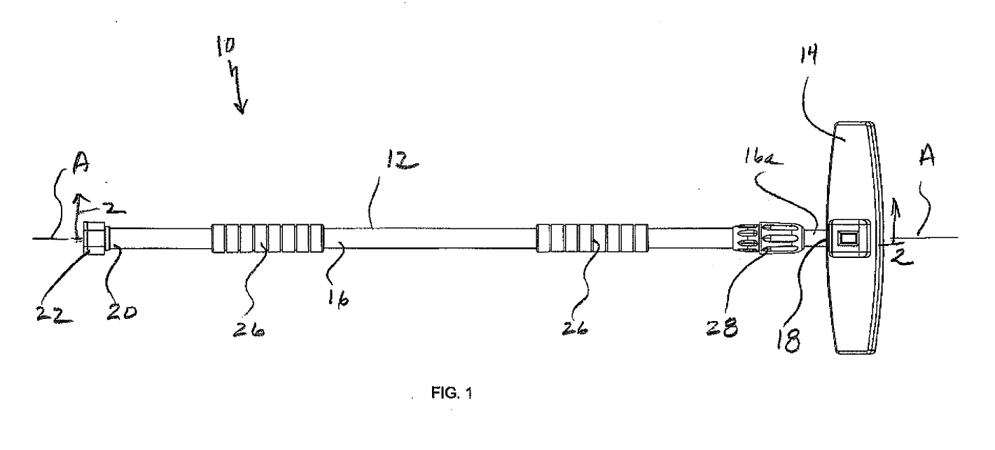

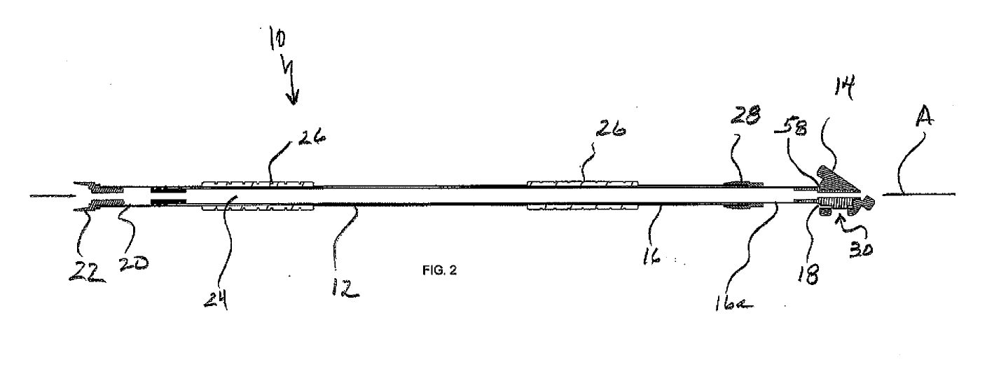

Referring to FIGS. 1 and 2, the present wash wand system is generally designated 10, and includes an elongate wash wand 12 defining a longitudinal axis “A” and having an attachment 14 secured thereto. As is known in the art, the attachment 14 is preferably a type of brush, wash mitt, scrubber or polishing cloth of the type conventionally used in cleaning. The wand 12 includes a tubular handle portion 16 having a first end 18 configured for releasable connection to the attachment 14 as will be described below, and an opposite second end 20. While the tube is preferably circular in transverse cross-section, other cross-sectional shapes are contemplated, including but not limited to oval and polygonal. As is known in the art, the second end 20 is optionally fitted with a rotating hose connection 22 for connection to a conventional garden hose. Thus, an interior 24 of the handle portion 16 (FIG. 2) defines a conduit for the passage of water to the attachment 14.

Also optionally included on the handle portion 16 is at least one annular grip 26, preferably made of a relatively soft or resilient grip-enhancing material such as rubber-like plastic or foam as is known in the art. In addition, the handle portion 16 is optionally provided in multiple telescoping segments 16, 16a to provide an extendable length. A rotating clamp 28 secures the relative extended longitudinal position of the segments 16, 16a as is known in the art.

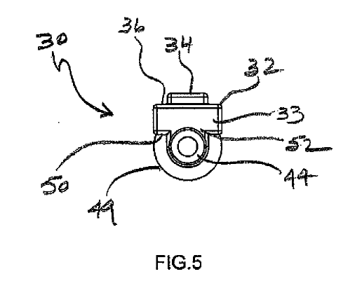

Referring now to FIGS. 2-5, at the first end 18 is provided a key formation, generally designated 30 and secured to the open end of the handle portion 16 by crimping, rivets or other fasteners as are well known in the art. Upon installation, the key formation 30 plugs the handle end and becomes the first end 18. The key formation includes a latch 32 enclosed within a box portion or formation 33 extending axially and having a polygonal, or preferably rectangular shape when viewed on end from a front end (FIG. 5). Included in the latch 32 is a retractable, reciprocating latch button 34 which projects from a top surface 36 of the latch.

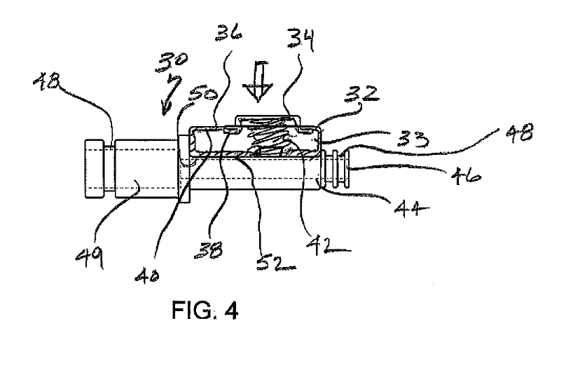

Referring now to FIG. 4, a laterally projecting flange 38 of the button 34, engages an underside 40 of the top surface 36. A biasing element 42, such as a spring, is located within the box-like latch and biases the button 34 to a locked or latched position. Downward pressure on the button 34 in the direction of the arrow overcomes the biasing force of the biasing element 42 to release the latch 32.

Also included on the key formation 30 is a water conduit 44. In the preferred embodiment, the water conduit 44 is in fluid communication with the interior 24 of the handle portion 16 so that for those embodiments having a hose connection 22, water will travel through the interior and the water conduit, and be emitted from the attachment 14. An outlet 46 of the conduit 44 is provided with at least one O-ring groove 48 for receiving a corresponding O-ring (not shown) to prevent leakage upon connection to the attachment 14.

Referring to FIGS. 4 and 5, it will be seen that the water conduit 44 is generally integral with the key formation 30 and is located below the latch 32, and on an opposite side of the latch from the latch button 34. Also, the latch 32 is isolated from the water conduit 44 in that water flowing through the conduit cannot come in contact with the latch. Nevertheless, the key formation 30 preferably includes the latch 32 and the water conduit 44 as an integral formation, such as a single molded piece (except for the button 34). Alternatively, the latch 32 and the water conduit 44 can be joined as by chemical adhesive, ultrasonic welding or the like. Opposite, the outlet 46, the key formation 30 has a handle end 49 dimensioned for insertion into the interior 24 of the handle portion 16 and also having at least one O-ring groove 48 for preventing unwanted water leaks.

Referring now to FIG. 5, when viewed from a front end, the generally rectangular latch 32 secured above the generally cylindrical water conduit 44 connected to a lower surface 50 of the latch forms a general “+”-shape. A generally planar upper edge 52 of the water conduit 44 connects to the lower surface 50 of the latch 32, as by being integrally joined thereto. In the present application, the “+”-shape is formed by the rectangular shape of the latch formation 33 defining the horizontal bar of the “+”, and the water conduit 44 and the latch button 34 generally extending below and above the latch formation to form the vertical bar of the “+”. Admittedly, the water conduit 44 defines a generally circular lower profile.

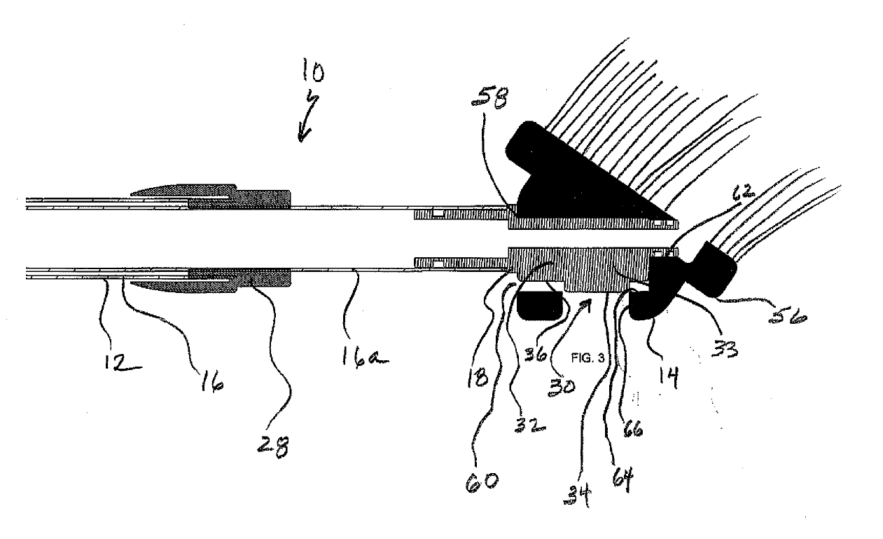

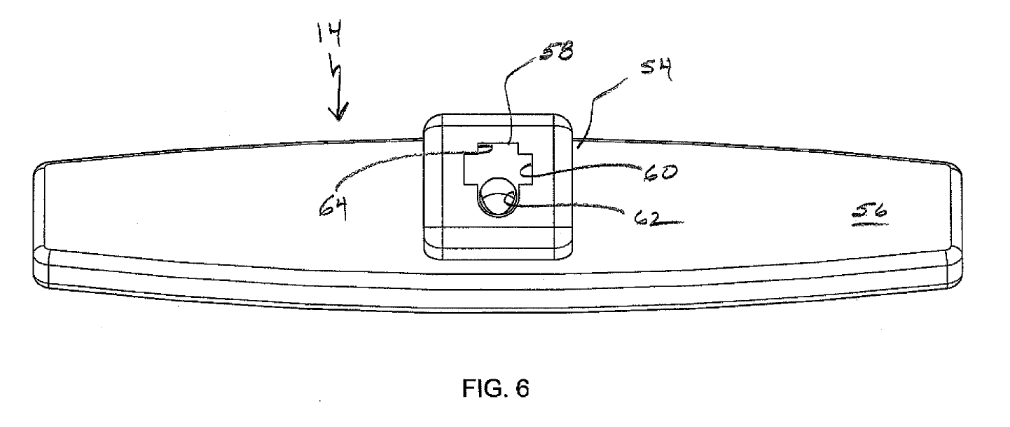

Referring now to FIGS. 3 and 6, the attachment 14 includes an attachment body 54 provided with a working portion 56 configured as a brush, mop, squeegee, polishing cloth, scrubber or the like, and a socket 58 configured for releasably receiving or accommodating the key formation 30. As such, the socket 58 is generally “+”-shaped (FIG. 6), similar to the key formation 30 when viewed on end. More specifically, the socket 58 defines a longitudinal axis which is coaxial with the longitudinal axis “A” of the wand 12.

Also included in the socket 58 is a cavity that includes a rectangular portion 60 for receiving the latch 32, and a generally cylindrical portion 62 for receiving the water conduit 44, said portions being in communication with each other to matingly receive the key formation 30. The socket 58 also has a recess 64 for accommodating the latch button 34. It will be understood that the cylindrical portion 62 of the socket 58 defines a throughbore to permit the emission of water through the working portion 56. In addition, the attachment body 54 includes a latch button access aperture 66 (FIG. 3) through which the latch button 34 projects once the key formation 30 is inserted into the socket 58. The aperture 66 is in communication with the socket 58. In addition, the aperture 66 is recessed to facilitate the location of the user's thumb upon the latch button 34.

During insertion, the latch button 34 momentarily depressed, typically by the user's thumb, until the key formation 30 is fully inserted, then the biasing element 42 forces the button into the access aperture 66 so that the key formation is securely engaged in the socket 58. Thus, the locking action of the latch button 34, coupled with a close mating tolerance between the socket 58 and the key portion 30 so that upon engagement, the attachment 14 is prevented from rotational movement about the axis, and also from movement relative to the wash wand 12 in the direction of the axis.

Once the user wants to remove the attachment 14, the operation is easily accomplished with one hand without tools by merely depressing the latch button 34 and axially moving the attachment away from the handle portion 16. A replacement attachment, or an attachment having other cleaning functions may easily be installed upon the key formation 30.

While a particular embodiment of the present wash wand attachment system has been shown and described, it will be appreciated by those skilled in the art that changes and modifications may be made thereto without departing from the invention in its broader aspects and as set forth in the following claims.

What is claimed:

1. A wash wand attachment system, comprising:
a wash wand defining a longitudinal axis and having a first end configured for receiving an attachment;
a key formation secured to said first end and having a releasable latch;
a wand attachment having a socket configured for releasably receiving said key formation; and
said key formation and said socket are constructed and arranged such that upon relative engagement, said attachment is prevented from rotational movement about said axis, and also from movement in the direction of said axis.

2. The attachment system of claim 1 wherein said wash wand has a second end opposite said first end and being configured for connection to a source of pressurized water.

3. The attachment system of claim 1 wherein said wash wand is telescopingly extendable in length.

4. The attachment system of claim 1 wherein said key formation is generally “+”-shaped when viewed on end.

5. The attachment system of claim 1 wherein said latch includes a box portion enclosing a retractable latch button.

6. The attachment system of claim 5 wherein said latch is mounted upon a generally cylindrical water conduit such that said latch is isolated from water in said passageway.

7. The attachment system of claim 5 further including a biasing member in said box portion biasing said latch button to a locked position.

8. The attachment system of claim 1 wherein said key formation, when viewed on end, includes a rectangular latch with a generally cylindrical water conduit secured to a lower edge of said latch.

9. The attachment system of claim 1 further including a retractable latch button reciprocating relative to a top surface of said latch.

10. The attachment system of claim 9 wherein said water conduit has a generally planar upper edge connecting said water conduit to a lower surface of said latch.

11. The attachment system of claim 10 wherein said socket includes a rectangular portion for receiving said latch, and a generally cylindrical portion for receiving said water conduit, said portions being in communication with each other.

12. A wash attachment for use with a wash wand attachment system including a wash wand defining a longitudinal axis and having a first end configured for receiving the attachment, a key formation secured to the first end and having a releasable latch, said attachment comprising:
a wand attachment body having a working portion and a generally “+”-shaped socket including a rectangular latch portion and a generally cylindrical water conduit portion in communication with an adjacent planar surface of said latch portion and configured for releasably receiving said key formation;
said socket being constructed and arranged such that upon relative engagement with the key formation, said attachment is prevented from rotational movement about the axis, and also from movement in the direction of the axis.

13. The attachment of claim 12 wherein said attachment body includes a latch button access aperture in communication with said socket.

14. A wash wand for use with a wash wand attachment system, including a wand attachment having a socket for releasably engaging said wash wand, the socket having a wand attachment body having a working portion and a generally “+”-shaped socket including a rectangular latch portion and a generally cylindrical water conduit portion in communication with an adjacent planar surface of the latch portion and configured for releasably receiving said wash wand, said wand comprising:
a wash wand having a handle portion defining a longitudinal axis and provided with a first end configured for receiving the attachment;
a key formation secured to said first end and having a releasable latch, said latch is generally “+”-shaped when viewed on end, including a rectangular latch with a generally cylindrical water conduit secured to a lower edge of said latch and a retractable latch button projecting from said rectangular latch opposite said water conduit; and
said key formation being constructed and arranged such that upon relative engagement with the attachment socket, the attachment is prevented from rotational movement about said axis, and also from movement in the direction of said axis.
